(19) United States
(12) Patent Application Publication
(10) Pub. No.: US 2013/0098287 A1
(43) Pub. Date: Apr. 25, 2013

(54) Microwave energy indicator

(71) Applicant: Robert Parker, Lombard, IL (US)

(72) Inventor: Robert Parker, Lombard, IL (US)

(21) Appl. No.: 13/573,758

(22) Filed: Oct. 3, 2012

Related U.S. Application Data
(60) Provisional application No. 61/542,489, filed on Oct. 3, 2011.

(51) Int. Cl. G01K 11/14

(52) U.S. Cl. CPC G01K 11/14
USPC 116/216

(57) ABSTRACT

An irreversible label or indicator of whether a surface or object has received microwave exposure and to delineate microwave heating or oven heating. Because microwave cooking has become an ubiquitous method for food preparation, and that energy and power in a microwave oven can vary from one unit to another, and within the spatial volume of the appliance, it is desirable to have a dynamic indicator that can provide an effective indicator of microwave exposure under such conditions.

### RELATED APPLICATION DATA

This application claims the priority of U.S. Provisional Patent Application No. 61/542,489, filed Oct. 3, 2011, which is hereby incorporated by reference in its entirety.

### BRIEF DESCRIPTION OF THE DRAWINGS

FIGS. 1A and 1B is a drawing of exemplary embodiment.

FIGS. 2A and 2B is a drawing of exemplary embodiment.

FIGS. 3A and 3B is a drawing of exemplary embodiment.

FIG. 4 is a drawing of exemplary embodiment.

FIGS. 5A and 5B is a drawing of exemplary embodiment.

### DETAILED DESCRIPTION

Various embodiments of the present invention will be described in detail with reference to the drawings. Reference to various embodiments does not limit the scope of the invention, which is limited only by scope of claims attached hereto. Additionally, any examples set forth in this specification are not intended to be limiting and merely set forth some of the many possible embodiments. Also, it is to be understood that the phraseology and terminology used herein is for the purpose of description and should not be regarded as limiting. The use of “including”, “comprising”, or “having” and variations thereof herein is meant to encompass the items listed thereafter and equivalents thereof as well as additional items.

There is a need in the art for an irreversible label or indicator of whether a surface or object has received microwave exposure and to delineate microwave heating or oven heating. Because microwave cooking has become an ubiquitous method for food preparation, and that energy and power in a microwave oven can vary from one unit to another, and within the spatial volume of the appliance, it is desirable to have a dynamic indicator that can provide an effective indicator of microwave exposure under such conditions. For example, it is a problem in the art that if a thin film of conductive material is placed in a microwave oven, the induced eddy currents can cause extreme heating, sparks and fires. Further, children may put food and toys in the microwave which may cause fires and explosions.

Accordingly, an irreversible label or indicator is disclosed which indicates whether microwave exposure has occurred and to delineate microwave heating or oven heating. Embodiments of the same are disclosed herein. In one embodiment, a simple reusable device to show the total integrated energy in a microwave oven in a particular location and to determine energy mapping or distribution is disclosed.

Microwave radiation is designed to have a frequency to excite water molecules in order to cause heating. It is well known that carbon will absorb microwave radiation. Basic experiments were performed with carbon impregnated paper with a resistance of 53,000Ω/□ and printed carbon on polyester film at 1,000Ω/□. It was found that the rate of energy absorption in low resistance 1,000Ω/□ was quite high. The 1,000Ω/□ carbon when printed on a polyester base and then placed in a 900 watt microwave oven with half a cup of water for 30 seconds started to melt the polyester substrate. The 53,000Ω/□ material also got warmer but did not reach such high temperatures under the same heating situation. By coating an irreversible theromochromic material over the carbon, one may determine the temperature as a function of microwave energy. It is also possible to measure the spatial microwave energy distribution.

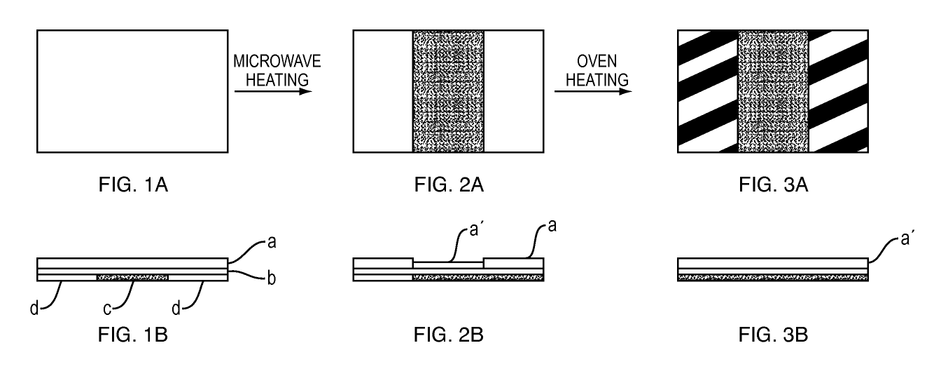

Referring to FIG. 1A, a label or indicator is disclosed wherein a conductive carbon area is printed or coated on transparent polyester film. The film may be of about 0.003″ to 0.005″ thick. A coating of an irreversible thermochromatic material with a melting point of 70° C. or 80° C. transition temperature (a) is printed on the polyester film. An inactive ink is printed on (d). Referring now to FIG. 1B, a side perspective is shown. In a further embodiment, the carrier transparent film (b) may be 0.003″ to 0.005″ thick transparent mylar or other substrate, but preferably a film. A carbon conductor (c) is printed preferably as shown, although it can be printed on the side next to layer (a). Layer (a) is an irreversible thermochromic with a trigger temperature from 51° C. to 90° C., but preferable 70° C.+/−1° C. Microionized polymer particles are loaded in a transparent binder, and when coated and dried these particles scatter light and appear as a white opaque coating. Upon reaching the melt point, they coalesce and become a transparent film disclosing the ink printed image below. Other irreversible thermochromics such as leuco dyes may be used.

Referring to FIG. 2A, a transition in the irreversible thermochromatic material is shown, i.e., it transitions from white to opaque. Referring now to FIG. 2B, a side perspective is shown. Carbon coating typically 1,000Ω/□ is heated by the microwave energy and causes the thermochromic to melt as in FIGS. 2A and 2B. The adjoining sections will not heat up so the opaque coating in this area will remain white. If the label is exposed to heating in an oven exceeding the set temperature, the whole label will change as in FIGS. 3A and 3B. It was found that if the 1,000Ω/□ was printed on paper, it was possible to initiate combustion, while with the film the substrate deforms enough to prevent a fire.

Referring to FIG. 3A, the same label or indicator is shown after exposure in a microwave appliance or oven wherein the temperature exceeded the irreversible thermochromatic material's set temperature exposing the printed display. Referring now to FIG. 3B, a side perspective is shown.

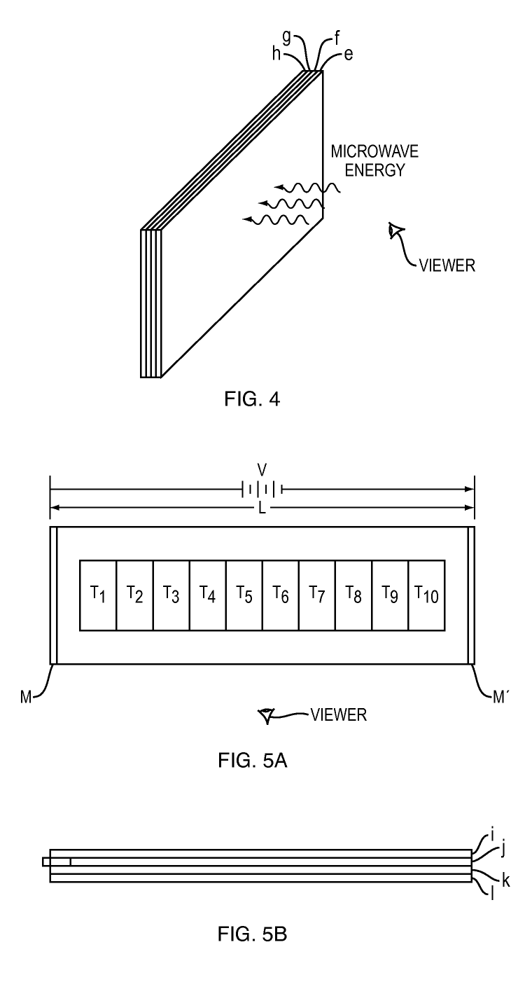

Referring to FIG. 4, a device to show the spatial energy distribution in a microwave oven is disclosed. Layers (c) and (h) are transparent polymer sheets; for example, 1/16″ acrylic or polycarbon. In an embodiment, one sheet on the back side can be opaque. Layer (f) is a reversible thermochromatic material of either micro-encapsulated liquid crystal film that may be approximate 0.004″ in thickness, or a reversible encapsulated leuco dyes. Layer (g) may be a carbon loaded paper at 53,000Ω/□ or more typically a film at 1,000Ω/□. Layer (h) may be another sheet of polymer to complete the sandwiched layers. Upon heating in the microwave the carbon will heat the reversible thermochromic material which may change color from 60° C.-80° C. An irreversible film may also be used. However, with the plastic sheets on either side, there is enough stored heat so that upon removal of the sandwich from the oven, the terrmochromic material will retain enough heat from the heat plastic to be viewable for a fraction of a minute and can be reused.

Referring to FIG. 5A and FIG. 5B, a microwave energy indicator embodiment is disclosed. The construction is similar to that disclosed in FIG. 4, with layers (i) and (I) as thin sheets of transparent plastic and layer (j) a coated carbon film that may be 53,000Ω/□ or more likely 1,000Ω/□. A reversible thermochromic thermometer liquid crystal may be inserted as layer (k). When placed in the microwave, the carbon will heat up depending on time and wattage, and will, accordingly, heat the thermometer to different temperatures. The total energy will be shown by the temperature rise from T₁ to T₁₀. To calibrate the unit and determine the watt density, we can apply a voltage to contacts M, to effect Joulean heating in the carbon. The watt density may be calculated by the below equation, wherein V is applied voltage, P is shee resistivity Ω/□, L=distance between applied voltage, and Q=watt density watts/in2 or cm2.

$$Q = \frac{{V}^{2}}{PL}$$

By applying the voltage at a given time (oven time) such that the temperature T is achieved as in the oven, one may calibrate and determine the watt density. In an embodiment, it is possible to use different conductive carbon with ONC temperature indicator; however, a liquid crystal thermometer design as disclosed may be used as well.

A method for determining watt density at a given location in an oven is disclosed, comprising the steps of determining if microwave heating has occurred (e.g. determining whether in conventional heating in an oven was used); determining the shape of the spatial microwave heating and energy in the oven volume; and measuring the watt density at a location in the oven.

In a further embodiment, carbon printed or coated conductive substrate with resistances from 1,000Ω/□ to 53,000Ω/□ in thermal contact with an irreversible thermochromic material is disclosed to show microwave heating. Alternatively, the areas on the same irreversible substrate without conductive carbon coating to show conventional heating is disclosed.

In a further embodiment, a conductive carbon coating in thermal contact with a reversible thermochromic material sandwiched between some transparent plates which are heated and retain the temperature to provide viewing time of the energy distribution is disclosed. Alternatively, an irreversible thermochromic material is disclosed.

In a further embodiment, a microwave energy or watt density device using a reusable film thermometer in thermal contact with a printed or coated carbon conductor sandwiched between transparent plates to measure watt density is disclosed. Alternatively, the device may be calibrated using Joulean heating with a known voltage and time.

What is claimed is:

1. A microwave radiation indicator, comprising
a transparent polyester film having a thickness of about 0.003″ to 0.005″, to a portion of which a conductive carbon area is applied;
a coating of irreversibly thermochromic material, on the polyester film;
wherein exposure to microwave energy causes the temperature of the conductive carbon to rise to at least the irreversible thermochromic transition temperature of the thermochromic material.
